(19) United States
(12) Patent Application Publication
(10) Pub. No.: US 2007/0050194 A1
(43) Pub. Date: Mar. 1, 2007

(54) Systems and methods for providing open access to scientific information

(76) Inventor: Kirk Michael Maxey, Ann Arbor, MI (US)

Correspondence Address: ARTZ & ARTZ, P.C., 28333 TELEGRAPH RD., SUITE 250, SOUTHFIELD, MI, 48034, US

(21) Appl. No.: 11/211,309

(22) Filed: Aug. 25, 2005

(51) Int. Cl. G06Q 99/00; G06Q 40/00

(52) U.S. Cl. 705/1; 705/35

(57) ABSTRACT

Disclosed are systems and methods for providing expedited, unlimited, unrestricted, free or minimal cost access to information such as scientific research results. The methods and systems include receiving information, identifying at least one product included in the received information, retrieving links associated with the identified product or products, publishing the received information and the retrieved links, and receiving revenue from the entities associated with the identified products. A portion of the received revenue is then expended on one or more of the costs of providing access to the received information. In one aspect of the invention, information is received and provided via the Internet, advertising links are provided in the form of thumbnail images, and revenue is generated for each click of a thumbnail image.

### BACKGROUND OF THE INVENTION

Embodiments of the present invention generally relate to systems and methods for providing access to information. More specifically, the present invention relates to systems and methods for providing expedited, unlimited, unrestricted, free or minimal cost access to scientific data such as scientific publications and scientific research results, as well as the commercial supplier data relevant to such data.

Some systems and methods for providing access to scientific data in hardcopy and electronic form are generally known. Scientific data such as articles may be obtained in hardcopy form from scientific journals, magazines, or the like. An example of one such article is article 200′ (FIG. 2). However, access to the information, or documents, contained in such scientific journals or magazines generally requires payment of a subscription fee or some other form of monetary payment.

Many such scientific journals, magazines, and the like additionally provide Internet access to their printed material via a Web site. In many instances, users may access this information electronically through an online subscription, as a benefit of the user's print subscription, or on an as-needed basis. To find the desired information, many such Web sites provide a search field such as search field 300′ via a Web page such as user interface Web page 302′ as depicted in FIG. 3. In the depicted example, upon clicking “search”, or otherwise activating the search, a list of results is then displayed to the user via a Web page such as hit list Web page 304′. A user may then select the desired article or the like from a list of hits such as hits 306a′ through 306d′. Upon clicking or otherwise accessing the desired hit, the user is then typically presented with a Web page dedicated to the hit such as hit access Web page 400′ (FIG. 4).

Referring now to FIG. 4, hit access Web page 400′ includes several options that allow a user to access the desired hit. First, a user may purchase a time-limited right to view the hit or a subscription to the printed publication by clicking the “subscribe now” link 402′. If a user chooses such an option, they will be subjected to several more Web pages requiring registration of the user with the Web site provider, as well as payment of a fee. Alternatively, if the user has already registered with the Web site provider, and has paid a subscription fee, the user may access the hit by entering his or her username and password into username field 404′ and password field 406′, respectively, and logging in to the Web site. Or, the user may be provided with an option of requesting the document via a document delivery service requiring registration and/or payment of a fee to such document delivery service after clicking the desired document delivery service link 408a′ through 408d′. Finally, the user is provided with the option of requesting the hit through his or her local library requiring registration, payment of a library fee, awaiting the availability of such hit at an accessible location, and/or arranging retrieval of the hit at the available location.

In addition to the collection of fees in exchange for provision of scientific data, the systems and methods for providing scientific data known in the art allow publishers of the scientific journals, magazines, and the like to control the content provided via print and electronically. Such control may potentially result in the loss of valuable scientific data due to criteria unrelated to scientific research such as the publisher's allocation of print or electronic space, editorial discretion, and the like. Similarly, the ability of commercial suppliers that provide products required for such scientific research to reach the readers of the published scientific data may be impeded by criteria such as the publisher's advertising sales force, high advertising prices, and the like. Furthermore, access to such scientific data may be delayed at the publisher's discretion as required by the needs of the publisher without regard for the needs of the scientific community. The combination of any one or more of these factors results in inefficient and substandard methods and systems for providing scientific researchers with access to scientific data.

### BRIEF SUMMARY OF THE INVENTION

Briefly stated, in one aspect of the present invention, a method of providing access to information is provided. This method includes receiving information, identifying at least one product included in the received information, retrieving links associated with the identified product or products, publishing the received information and the retrieved links, and receiving revenue from the entities associated with the identified products. A portion of the received revenue is then expended on one or more of the costs of providing access to the received information.

In another aspect of the present invention, a system for providing access to information is provided. This system includes at least one computing device for transmitting the information and at least one data system coupled to the computing device via a network connection for receiving the information, identifying at least one product included in the information and/or retrieving at least one link associated with the product, and publishing the information and the links. Revenue is received from at least one entity associated with at least one of the products for electronic publishing of at least one of the links, and at least a portion of the collected revenue is expended on at least one cost of providing the system.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE SEVERAL VIEWS OF THE DRAWINGS

A further understanding of the present invention can be obtained by reference to the embodiments set forth in the illustrations of the accompanying drawings. Although the illustrated embodiments are exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 depicts a flowchart of an exemplary method of providing access to information in accordance with one embodiment of the present invention.

FIG. 2 depicts a hardcopy article for providing information in accordance with the prior art.

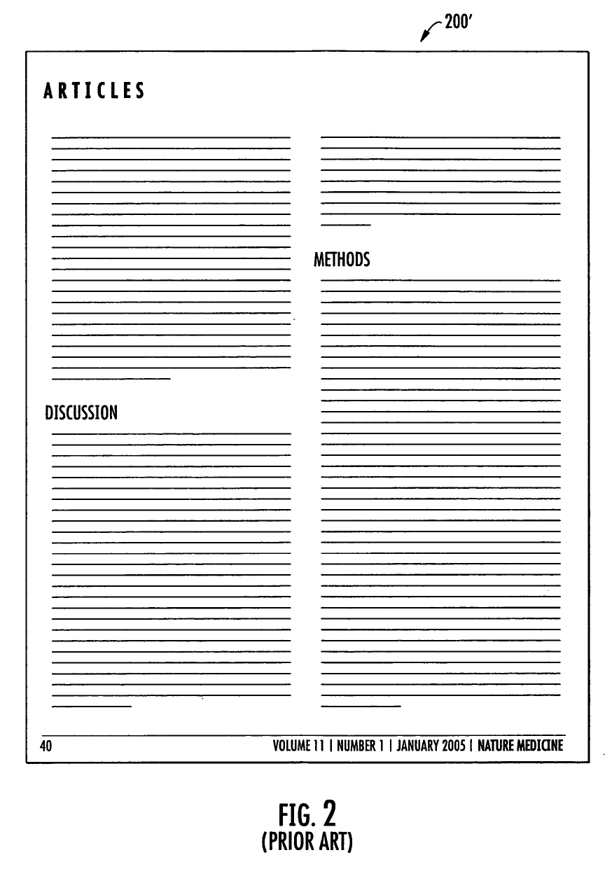

FIG. 3 depicts user interface and hit list Web pages for allowing a user to search for information in accordance with the prior art.

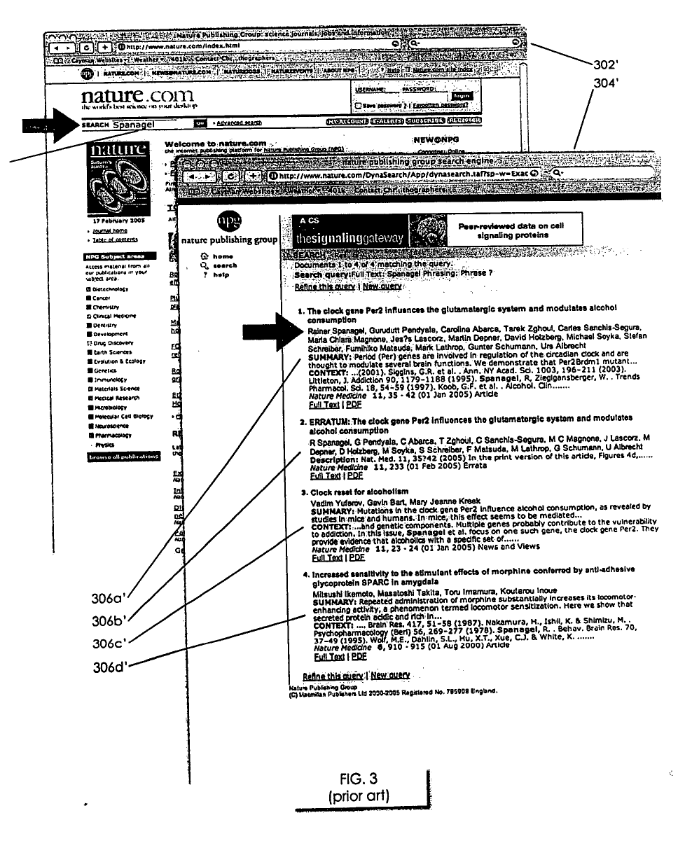

FIG. 4 depicts a hit access Web page for allowing a user to select a hit in accordance with the prior art.

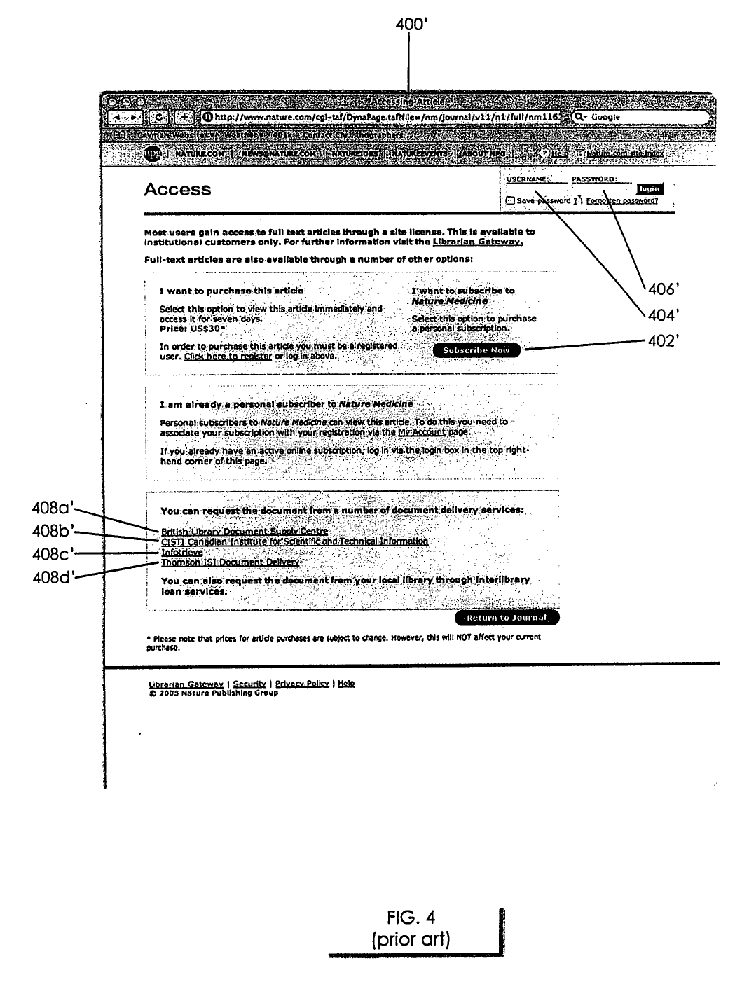

FIG. 5 depicts a schematic diagram of an exemplary computer environment for providing access to information in accordance with an embodiment of the present invention.

FIG. 6 depicts an exemplary Web page for providing access to information in accordance with an embodiment of the present invention.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of one embodiment (as well as some alternative embodiments) of the present invention.

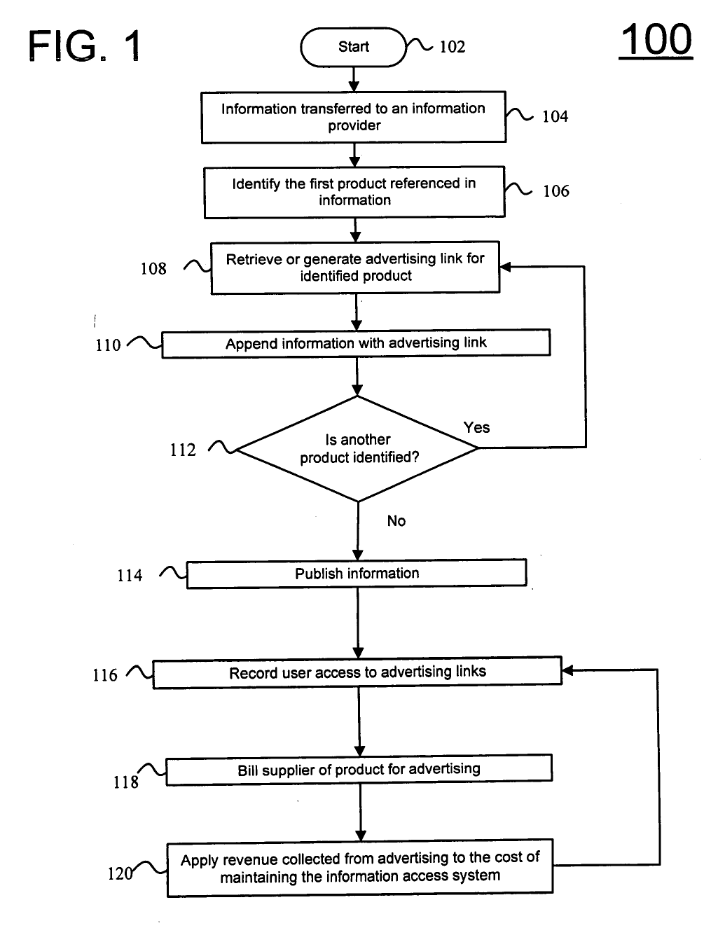

Referring first to FIG. 1, illustrated is a flow diagram of an exemplary embodiment of a process for providing access to information such as scientific research data. Process 100 begins at 102. For example, at 102, an author has created information such as a manuscript. In one aspect of the present invention, these manuscripts may include scientific publications such as those publishing scientific research results. Process 102 then proceeds to 104.

At 104, the author's information is transferred to an information provider. In one aspect of the present invention, the information provider may be a self-supporting non-profit organization designed to immediately publish an unlimited quantity of unedited information at little or no cost to the readers and users. Alternatively, in other embodiments of the present invention, the information provider may be an existing for-profit publisher. Such a publisher may be a print-only, Internet-only, or combination print and Internet publisher. Or, alternatively, the information provider may be a commercial supplier. However, virtually any entity may act as an information provider without departing from the scope of the present invention. Regardless of the method of publishing, the systems and methods of the present invention allow information providers to obtain the revenue required to maintain the infrastructure for the publishing system (e.g., editors, peer review resources, network servers, etc.) from sources other than the readers and users.

However, implementation of the systems and methods of the present invention may be facilitated for information providers who issue printed publications since it is likely that contracts have already been secured with one or more of the information's authors and commercial advertisers. The authors' contracts are likely to cover key provisions such as copyright provisions, whereas the commercial advertisers' contracts are likely to cover key advertising provisions for advertisements placed within the printed publications. In this scenario, the existing contracts could be easily modified to accommodate the systems and methods of the present invention. For example, in one embodiment of the present invention, existing contracts with authors would be revised to gain the author's consent to add advertising links to published versions of the author's information. Also, optionally, these contracts may be modified to include additional terms such as “non-endorsement” or “conflict of interest” terms. The former term could allow or disallow the author's name to be used as an endorsement for the commercial advertisers' products and the latter term could be used to clarify whether an author has a personal financial interest in the commercial advertisers' products. Similarly, the existing contracts with the commercial advertisers could be easily modified to require the advertiser to provide corporate artwork, images, logos, advertisements, links, and the like for appendage to the authors' information, as well as payment for the advertising services provided by the publishing system. Some examples of payment schemes are discussed in greater detail below with respect to step 118.

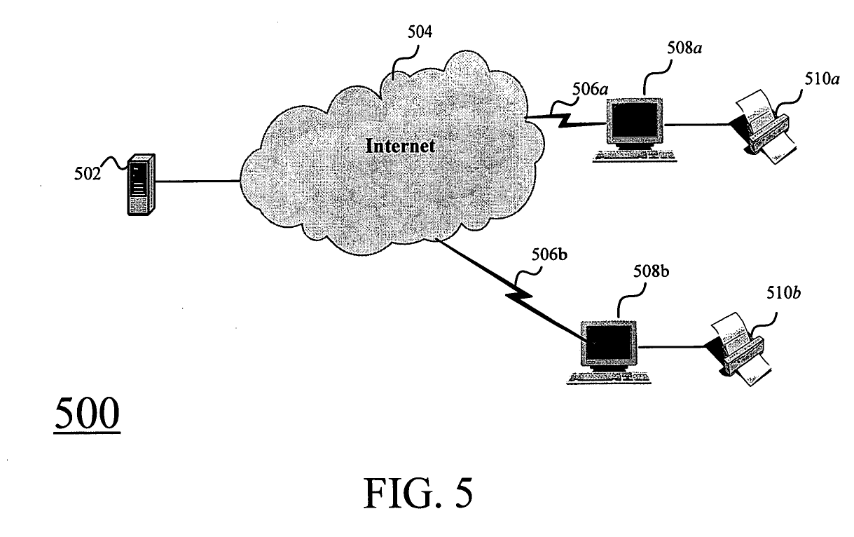

The information provider may accomplish 104 using any one of a variety of methods. In one aspect of the present invention, the author submits the information to the information provider non-electronically (e.g., hardcopy sent via regular mail). In this scenario, the information is received by the information provider's staff and is manipulated as necessary to process the information for publication. Alternatively, the author's information may be submitted electronically as discussed in greater detail below with respect to FIG. 5.

After the author's information has been transferred to the information provider, process 100 proceeds to step 106, at which a first product (e.g. chemical formula, chemical compound, mechanical or electrical device, research tools, research equipment, etc.) is identified. In the context of this patent application, a product may be any item provided for sale. In one embodiment of the present invention, products are identified by a computerized keyword search executed by a keyword-driven search engine resident on the information provider's computing system. However, other methods of identifying products may be substituted (e.g., manual identification) without departing from the scope of the present invention. Optionally, identification of products may be limited to one or more specific subsections of the information (e.g., the Materials and Methods section of a scientific paper).

After a product is identified, process 100 proceeds to 108 at which an advertising link associated with the identified product is retrieved. Advertising links may include graphical images for print in hardcopies of published information. In some embodiments, such advertising links are automatically generated by searching the Internet to determine Web site links applicable to the product. In some embodiments of the present invention, commercially available software (e.g., browser plug-ins) such as TopText, smart tags, or the like, or a modified version thereof, may be incorporated. However, other methods of retrieving advertising links may be substituted without departing from the scope of the present invention. For example, such links may be stored with the products as part of a database (e.g., a Microsoft® Access® database), cross-reference table, matrix, the Internet or other such data source.

Furthermore, such links may comprise any one of a variety of forms without departing from the scope hereof including, but not limited to, graphical images, logos, thumbnails (i.e., miniature representations of a page, image, or the like), hyperlinks, hypertext, virtual hypertext, smart tags, TopText, hypergraphics, and hot spots. Thereafter, at 110, the retrieved link is appended to the electronic version of the respective information and process 100 proceeds to 112. At 112, the information is queried to determine if any other products exist. If yes, process 100 returns to 108. If no, process 100 proceeds to 114.

At 114, all products have been identified and the information is ready to be published. In one embodiment of the present invention, publishing includes uploading the information to a server or the like and associating it with an information search engine. The latter may be accessed via a portal such as a Web page of the information provider's Web site. The information search engine may be configured to identify available manuscripts via one or more criteria including, but not limited to, author, subject matter, one or more keywords, and title. In such an embodiment, published information is retrieved by entering search criteria relevant to the information in the information search engine. Upon executing the search, the information, as well as other information relating to the entered search criteria, is typically displayed to the user. The information is then displayed to the user for minimal or zero cost. In addition to the text of the information, all advertising links are also displayed to the user. Consequently, if a user wished to obtain information (e.g., technical specifications, pricing, etc.) for a specific part, chemical, or other product referenced in the information, the user simply clicks the advertising link to retrieve additional information. In one aspect of the present invention, clicking the advertising link may redirect the user to the respective manufacturer's Web site. In another aspect of the present invention, clicking the advertising link may access additional product information resident in the publisher's computing system. In this manner, electronic advertising is provided for each manufacturer associated with an advertising link.

In some embodiments of the present invention, all steps, or a portion of the steps, preceding step 116 may be performed automatically by a computerized system without human intervention. In these embodiments, the information may be published quickly with minimal or no delay. Furthermore, a virtually unlimited quantity of information may be published as originally written. Such systems and methods would allow scientists to freely and quickly exchange information such that the speed of scientific advancement may be quickened. Furthermore, such systems and methods would allow scientists to control the flow of scientific information while allowing commercial suppliers and information providers to profit from the systems and methods. Methods of pre-approving or pre-screening authors or censoring submitted information may be implemented to prevent the submission of inappropriate data.

After the information has been published, process 100 proceeds to 116. At 116, user access to each advertising link is recorded. In one embodiment of the present invention, process 100 tallies each individual user's access to additional product information (e.g., definitions, specifications, pricing, material safety data sheets, etc.) through each individual advertising link. In some embodiments of the present invention, such access may be correlated with the respective user to provide marketing information to the manufacturers participating in the publishing system. Such information may provide valuable insight to the manufacturers regarding their consumer markets. The users of the publishing system may provide permission to use their personal information in exchange for free or minimal cost access to the publishing system. Supply of the marketing data to the manufacturers or commercial suppliers may be another revenue-generating item of the present invention that may be used in whole or in part to fund open access to information.

However, alternate methods of recording user access to the advertising links may be incorporated. For example, the length of time that an advertiser's links are published may be recorded. Or, alternatively, process 100 may tally each individual user's access to additional product information based on the manufacturer. In other words, all access to a specific manufacturer's products shall be tallied without a breakdown for each of the manufacturer's specific products. Many such methods of recording user access to advertising links may be substituted without departing from the scope of the present invention.

Next, process 100 proceeds to 118, at which the owners of the product associated with the accessed advertising links are billed for the access recorded as per 116. In one aspect of the present invention, each owner is billed for each access (e.g., the owner is billed for each instance in which a user clicked on an advertising link associated with any one of the owner's products). In another aspect of the present invention, such owners may be billed for a period of time during which its respective advertising links are active in the publishing system (e.g., on a daily, monthly, or annual basis). Such billing may be per product or per manufacturer. However, other such methods of billing user access to advertising links may be substituted without departing from the scope of the present invention.

Finally, at 120, the electronic advertising revenue collected from the owners of the products as per 118 is applied to the cost of maintaining the publishing system. Process 100 then returns to 116, at which it continually records and bills access to advertising links such that the cost of the publishing system is entirely or partially paid by the commercial advertisers. In some instances, the cost to the commercial advertisers may be paid through the increased sales achieved by advertising via the publishing system. In this manner, the cost of the users′ access to the publishing system may be greatly minimized and/or completely eliminated.

Turning now to FIG. 5, illustrated is a schematic diagram of an exemplary computer environment 500 for providing access to information in accordance with an embodiment of the present invention. In the depicted embodiment, computer environment 500 includes data system 502, Internet 504, connections 506, computing devices 508, and printers 510.

Computing devices 508 are connected to Internet 504 via connections 506, which may be any form of Internet connection known in the art or yet to be invented. Connections 506 may include, but are not limited to, telephone lines (XDSL, T1, leased lines, etc.), cable lines, power lines, wireless transmissions, and the like. Computing devices 508 include any equipment necessary (e.g., modems, routers, etc.), as is known in the art, to facilitate such communication with the Internet. Computing devices 508 may optionally be equipped with printing devices 510 to facilitate creation of a hardcopy of information retrieved from the information provider. Data system 502 is also connected to Internet 504 using one of the aforementioned methods or other such methods known in the art.

In the depicted system, an author may transfer information to an information provider via a computing device connected to Internet 504 such as computing device 508a or 508b. Such a computing device may be the author's personal computer, an Internet cafe computer, a computerized portable electronic device (e.g., a personal data assistant, cell phone, etc.), or the like. Using the system exemplified in FIG. 5, such transfer may include upload of an electronic form of the information from a computing device 508 via Internet 504 to the information provider's data system 502 (e.g., server, mainframe, computer, etc.). In another aspect of the present invention, the author transmits the information directly to the publisher in electronic format without upload (e.g., via electronic mail). Such transmission may also be performed at a computing device 508 via Internet 504, however, in this scenario, manipulation by the information provider's staff may be required prior to transferring the author's information to the information provider's data system 502.

After the author's information has been transferred to the information provider, products contained within the information may be identified. In one embodiment of the present invention, products are identified by a computerized keyword search executed by a keyword-driven search engine resident on the data system 502. In an environment such as computer environment 500, such products may be automatically identified, without human intervention, by data system 502 upon the initial receipt of the information from the author. However, other methods of identifying products may be substituted (e.g., manual identification) without departing from the scope of the present invention. For example, manual identification may be performed by the information provider's staff after the information is received from the author via Internet 504 and before transferring such information to data system 502.

After one or more products have been identified, advertising links associated with the identified product may be retrieved. In an environment such as computer environment 500, such advertising links may be automatically generated or retrieved, without human intervention, by data system 502 after all products have been identified. Such automatic generation may be performed by searching Internet 504 to determine Web site links applicable to the product. However, other methods of retrieving advertising links may be substituted without departing from the scope of the present invention. For example, such links may be manually added and/or edited by a user of data system 502.

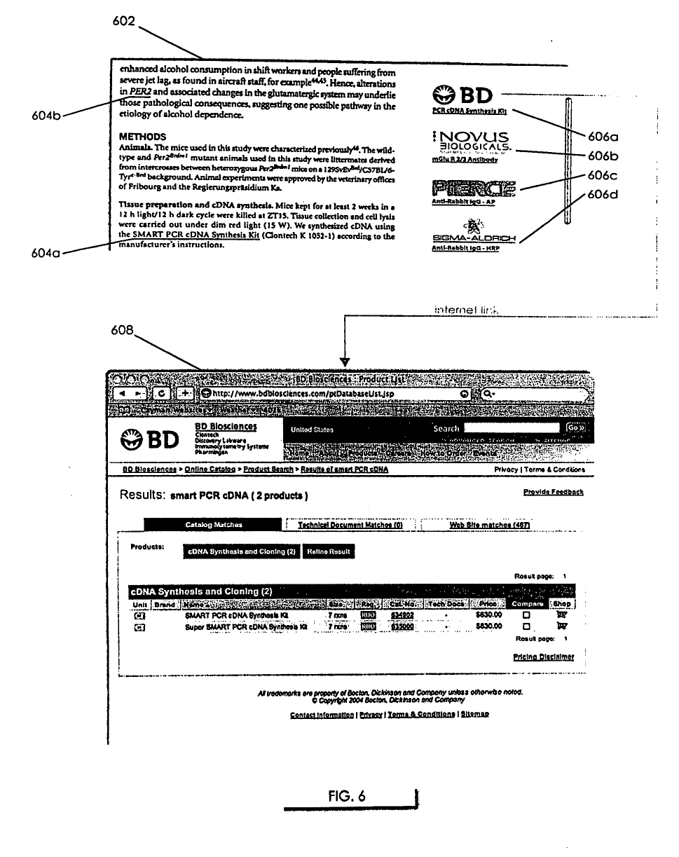

After the advertising links have been retrieved or generated, they may be appended to the information. In one aspect of the present invention, the advertising links are appended such that they will appear proximate to the reference(s) to the product as it occurs in the original form of the author's information. Such links may be provided in a variety of forms including, but not limited to, text links such as text links 604a and 604b and thumbnail links such as thumbnail links 606a-606d (FIG. 6). Thereafter, the appended information may be electronically published. In one aspect of the present invention, electronic publishing includes storing an electronic appended version of the author's information on data system 502 such that it may be accessed by any user or reader via Internet 504 using any computing device connected thereto such as computing device 508.

After the appended information has been electronically published, a user or reader may find the desired information through a mechanism such as an information search engine accessed via a portal such as a Web page of the information provider's Web site. Upon finding a desired piece of information, the information, as well as other information relating to it such as advertising links, is displayed to the user at little or zero cost.

One example of displayed information in accordance with the present invention is depicted in FIG. 6. As shown in the example illustrated in FIG. 6, the desired information is displayed to a user via a dedicated information Web page 602. The left side of information Web page 602 includes the scientific publication or data originally submitted by the author including text links such as text links 604a and 604b. Such text links may be offset from non-linked text via color, underlining, italicizing, and the like. The right side of information Web page 602 prominently displays advertising links such as thumbnail links 606a-606d. For example, in the depicted embodiment, Clontech was identified as a product and was associated with text link 604a and advertising link 606a for a PCR cDNA Synthesis Kit manufactured by BD Biosciences. Similarly, PER2 was identified as a product and was associated with text link 604b and advertising link 606b for PER2 antibodies. Consequently, another reader wishing to duplicate the testing detailed in the information, or perform a related test, could simply click, or otherwise activate, text links 604a and 604b, as well as advertising links 606a and 606b to order the necessary materials. In accordance with the systems and methods of the present invention, the owners of the products (e.g., BD Biosciences and Novus-Biologicals) pay for such prominent display of advertising links associated with their products to a highly targeted audience of scientists, researchers, and the like.

Still referring to FIG. 6, as the information is read or otherwise accessed, a reader may access additional information for a product contained therein by simply clicking, or otherwise activating, a respective advertising link such as text links 604a and 604b and thumbnail links 606a-606d. Such additional information may be displayed in the form of commercial information Web page 608, which allows the user to obtain information such as pricing, technical specifications, and the like. The displayed information may be easily printed to hardcopy via a printing device such as printing device 510 and the like. The ease with which information for commercial products may be accessed and/or purchased provides incentive for payment of such advertising by the owner of the respective products, thereby providing a means with which the information system may be self-supporting (i.e., it does not require payment by a user).

Referring back to FIG. 5, after the appended information has been published, data system 502 may monitor access to each link for billing purposes. Such monitoring may be performed using software known in the art. The accrued data may then be input to a billing system included within or separate from data system 502. This billing system then automatically generates invoices for each owner of the products. The revenue generated from such billing is then applied to the cost of providing the system as described above in greater detail with respect to FIG. 1.

In some embodiments of the present invention, revenue may be generated from entities other than product suppliers. In one such embodiment, entities may simply purchase space in a designated advertising portion of the publishing system for a predetermined length of time. In another such embodiment, entities may sponsor the publishing system, specific researchers, specific research companies, specific product suppliers, etc. as a charitable contribution, as part of a joint venture, as part of a strategic alliance, etc. In such embodiments, the sponsoring entities may be advertised as such and/or touted for their goodwill, sponsorship of scientific research, and the like. Furthermore, such advertising and/or recognition of sponsorship may optionally include links to such entity's Web pages. In accordance with the present invention, such advertising may be published and monitored in the same manner described above for product advertising links, and revenue generated by these non-product entities may also be allocated to support the open access nature of the publishing system.

When the systems and methods of the present invention are implemented in a scientific research setting, such systems and methods allow scientists and other such users to exchange information such as unedited scientific research results immediately at little or no cost, thereby facilitating and potentially increasing the rate of scientific advancement. Simultaneously, the owners of the products that participate in the publishing system receive advertising aimed at a highly specialized consumer that requires little or no marketing budget since the advertisement links are automatically generated based upon the scientists' information rather than the owners' in-house marketing personnel. Furthermore, the scientists' inclusion of the products in their information provides the owners with free testimonials attesting to the benefits of the owners' products. In some aspects of the present invention, the users may provide permission for such testimonials to be used by the owners of the products in other forms of advertisement in exchange for the free or minimal cost access to the publishing system. In this manner, the cost of advancing science may be shifted at least in part from the scientists to the commercial advertisers.

Although several processes have been disclosed herein as software, it may be appreciated by one of skill in the art that the same processes, functions, etc. may be performed via hardware or a combination of hardware and software. Similarly, although the present invention has been disclosed with respect to hardwired systems, these concepts may be applied to wireless systems and hybrid hardwired and wireless systems without departing from the scope of the present invention.

While the present invention has been described with reference to one or more embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. A method of providing access to information comprising:
receiving information;
identifying at least one product included in said information;
retrieving at least one link associated with said product;
electronically publishing said information and said link;
receiving base revenue from at least one first entity associated with at least one of said products for electronic publishing of at least one of said links; and
expending at least a portion of said base revenue on at least one cost of providing said method.

2. A method according to claim 1, wherein said information is electronically published via the Internet.

3. A method according to claim 1, wherein said links include at least one of the group consisting of thumbnails, hyperlinks, hypertext, virtual hypertext, smart tags, TopText, hypergraphics, and hot spots.

4. A method according to claim 1, wherein a computerized algorithm automatically searches said information to identify at least one of said products.

5. A method according to claim 1, wherein said product includes at least one of the group consisting of a chemical formula, a chemical compound, a mechanical or electrical device, a research tool, and research equipment.

6. A method according to claim 1, wherein said information includes at least one of the group consisting of a manuscript, scientific research results, and a scientific publication.

7. A method according to claim 1, wherein a computerized algorithm automatically retrieves at least one of said links.

8. A method according to claim 7, wherein said algorithm automatically retrieves at least one of said links from at least one of the group consisting of a database, a cross-reference table, a matrix, and the Internet.

9. A method according to claim 1, wherein at least one of said first entities is a commercial supplier.

10. A method according to claim 9, wherein at least one of said commercial suppliers provides products related to said information.

11. A method according to claim 10, wherein said supplies include at least one of the group consisting of reagents, materials, devices, and software.

12. A method according to claim 1, said method further comprising:
appending said link to said information.

13. A method according to claim 12, wherein said appending is performed by a computerized algorithm.

14. A method according to claim 12, wherein said appending includes inserting said links within at least one of the group consisting of the text and the margins of said information.

15. A method according to claim 12, wherein at least one of the group consisting of said identifying, said retrieving, and said appending is performed manually.

16. A method according to claim 1, said method further comprising:
recording user access to at least one of said links.

17. A method according to claim 1, wherein a user activates said link to access additional information.

18. A method according to claim 17, wherein said additional information includes at least one of the group consisting of definitions, specifications, pricing, and material safety data sheets.

19. A method according to claim 17, wherein said additional information is located on at least one Web page maintained by at least one of said first entities.

20. A method according to claim 17, wherein said activation includes clicking on said link.

21. A method according to claim 1, said method further comprising:
editing said information prior to said electronic publication.

22. A method according to claim 21,
wherein said links are suggested by a computerized algorithm; and
wherein said editing includes at least one of the group consisting of accepting, rejecting, and modifying said suggested links.

23. A method according to claim 1, wherein said base revenue is determined using at least one of the group consisting of cost per access of said link, cost per access of a subset of said links, and cost for electronically publishing said link for a predetermined time period.

24. A method according to claim 1, said method further comprising:
receiving incremental revenue from at least one second entity not associated with said products for electronic publishing of advertising material; and
expending at least a portion of said incremental revenue on at least one cost of providing said method.

25. A method according to claim 24, wherein said second entity sponsors at least one of the group consisting of said method, at least one of said products, at least one supplier of said products, and at least one supplier of said information.

26. A system for providing access to information comprising:
at least one computing device for transmitting said information; and
at least one data system coupled to said computing device via a network connection,
wherein said data system receives said information and performs at least one of the group consisting of identifying at least one product included in said information and retrieving at least one link associated with said product;
wherein said data system publishes said information and said link;
wherein base revenue is received from at least one first entity associated with at least one of said products for electronic publishing of at least one of said links; and
wherein at least a portion of said base revenue is expended on at least one cost of providing said system.

27. A system according to claim 26, wherein said network connection is an Internet connection.

28. A system according to claim 26, wherein said links include at least one of the group consisting of thumbnails, hyperlinks, hypertext, virtual hypertext, smart tags, TopText, hypergraphics, and hot spots.

29. A system according to claim 26, wherein a computerized algorithm executed by at least a portion of said data system automatically searches said information to identify at least one of said products.

30. A system according to claim 26, wherein said product includes at least one of the group consisting of a chemical formula, a chemical compound, a mechanical or electrical device, a research tool, and research equipment.

31. A system according to claim 26, wherein said information includes at least one of the group consisting of a manuscript, scientific research results, and a scientific publication

32. A system according to claim 26, wherein a computerized algorithm executed by at least a portion of said data system automatically retrieves at least one of said links.

33. A system according to claim 32, wherein said algorithm automatically retrieves at least one of said links from at least one of the group consisting of a database, a cross- reference table, a matrix, and the Internet.

34. A system according to claim 26, wherein at least one of said entities is a commercial supplier.

35. A method according to claim 34, wherein at least one of said commercial suppliers provides supplies related to said information.

36. A system according to claim 35, wherein said supplies include at least one of the group consisting of reagents, materials, devices, and software.

37. A system according to claim 26, wherein said data system appends said links to said information.

38. A system according to claim 37, wherein said appending is performed by a computerized algorithm executed by at least a portion of said data system.

39. A system according to claim 37, wherein said appending includes inserting said links within at least one of the group consisting of the text and the margins of said information.

40. A system according to claim 26, wherein said data system records user access to at least one of said links.

41. A system according to claim 26, wherein a user activates said link to access additional information.

42. A system according to claim 41, wherein said additional information includes at least one of the group consisting of definitions, specifications, pricing, and material safety data sheets.

43. A system according to claim 41, wherein said additional information is located on at least one Web page maintained by at least one of said entities.

44. A system according to claim 41, wherein said activation includes clicking on said link.

45. A system according to claim 26, wherein said information is manually edited prior to said publication.

46. A system according to claim 44,
wherein a computerized algorithm executed by at least a portion of said data system suggests said links; and
wherein said editing includes at least one of the group consisting of accepting, rejecting, and modifying said suggested links.

47. A system according to claim 26, wherein said base revenue is determined using at least one of the group consisting of cost per access of said link, cost per access of a subset of said links, and cost for electronically publishing said link for a predetermined time period.

48. A system according to claim 26,
wherein incremental revenue is received from at least one second entity not associated with said products for electronic publishing of advertising material; and
wherein at least a portion of said incremental revenue is expended on at least one cost of providing said system.

49. A system according to claim 26, wherein said second entity sponsors at least one of the group consisting of said system, at least one of said products, at least one supplier of said products, and at least one supplier of said information.
